(19) United States
(12) Patent Application Publication
(10) Pub. No.: US 2006/0240218 A1
(43) Pub. Date: Oct. 26, 2006

(54) Paintable nonofiber coatings

(75) Inventor: J. Wallace Parce, Palo Alto, CA (US)

Correspondence Address: QUINE INTELLECTUAL PROPERTY LAW GROUP, P.C., P O BOX 458, ALAMEDA, CA, 94501, US

(73) Assignee: NANOSYS, Inc., Palo Alto, CA (US)

(21) Appl. No.: 11/411,431

(22) Filed: Apr. 25, 2006

Related U.S. Application Data
(60) Provisional application No. 60/674,864, filed on Apr. 26, 2005.

(51) Int. Cl. B32B 5/00

(52) U.S. Cl. 428/98

(57) ABSTRACT

This invention provides novel superhydrophobic coatings comprising nanofiber heterostructures, as well as methods of creating and using such coatings.

### CROSS-REFERENCE TO RELATED APPLICATIONS

This application claims benefit of, and priority to, U.S. Provisional Application No. 60/674,864 filed Apr. 26, 2005, entitled “PAINTABLE NANOFIBER SURFACES.” Such prior application is hereby incorporated by reference in its entirety.

Additional applications to which the coatings herein can be applied include those which are disclosed in greater detail in co-pending U.S. patent application Ser. No. 10/828,100, filed Apr. 19, 2004, which is a continuation-in-part of U.S. patent application Ser. No. 10/661,381, filed Sept. 12, 2003, which claims priority to U.S. Provisional Patent Application No. 60/463,766, filed Apr. 17, 2003; U.S. patent application Ser. No. 10/833,944, filed Apr. 27, 2004, which claims priority to U.S. Provisional Application Ser. No. 60/466,229, filed Apr. 28, 2003; and to U.S. patent application Ser. No. 10/840,794 filed May 5, 2004, which is a continuation-in-part of U.S. patent application Ser. No. 10/792,402, filed Mar. 2, 2004, which claims priority to U.S. Provisional Patent Application Ser. Nos. 60/468,390, filed May 6, 2003 and 60/468,606 filed May 5, 2003, each of which is incorporated by reference in their entirety herein.

### FIELD OF THE INVENTION

The invention relates primarily to the field of nanotechnology. More specifically, the invention relates to superhydrophobic nanofiber heterostructure coatings, as well as to the making and usage of such coatings.

### BACKGROUND OF THE INVENTION

Water repellency, or hydrophobicity, of materials is of great importance in myriad applications from aesthetic to industrial uses. For example, increased hydrophobicity is often desirable in surfaces subject to ice/snow accumulation or exposure to water. In yet other instances lipophobicity (lipid repellency) and/or amphiphobicity (repellency of both water and lipids) are also desired (e.g., in transport or storage of lipid based fluids, etc.).

Alternative to, or in addition to, hydrophobicity, many applications require or benefit from superhydrophobicity. Recently, approaches by the inventor and co-workers have focused on use of various nanotechnology constructs to produce surfaces that are superhydrophobic. However, creation of nanofiber based superhydrophobic materials may be more difficult in certain situations or for certain surfaces (e.g., those surfaces not able to withstand high temperatures needed to produce nanofibers, etc.).

A welcome addition to the art would be a surface or surface layer coating which can be tailored to various degrees and types of superhydrophobicity, which could easily be applied to many different surfaces and which could be used in a variety of settings/situations. The current invention presents these and yet other novel benefits which will be apparent upon examination of the following.

### SUMMARY OF THE INVENTION

In various aspects herein, the invention comprises compositions composed of a plurality of heterostructure nanofibers and a matrix (optionally a liquid matrix). In various embodiments of such compositions, each member of the plurality of nanofibers (or at least a majority of the members) comprises a hydrophobic end and a hydrophilic end, while in other embodiments, each member (or a majority of the members) comprises lipophobic/lipophilic ends or amphiphobic/amphiphilic ends. In yet other embodiments, one end of a majority of the members can comprise a hydrophobic or hydrophilic portion while the other end is neutral in terms of hydrophobicity. In yet other embodiments, both ends can be hydrophobic or hydrophilic, with one end being substantially more hydrophobic/hydrophilic than the other. In some embodiments the matrix comprises an aqueous fluid, and in other embodiments it comprises a dry matrix, while in other embodiments the matrix comprises a nonaqueous fluid. In all embodiments, the matrix can optionally comprise a curable matrix (e.g., one cured or set by UV, heat, addition of setting compounds, humidity level, etc.). In the various embodiments, one or both ends of each of the members (or a majority of the members) can comprise one or more surface applications such as a coating or modification on the nanofiber, an oxide layer, specific moieties added to the nanofiber, etc. Such surface applications can optionally alter or enhance the hydrophobicity, hydrophilicity, and/or or enhance stability of the nanofiber within the matrix. In the various embodiments, the matrix can optionally be applied to a surface and cured, with one end of each nanofiber (or at least a majority of the members) set within the cured matrix and the other end (e.g., the hydrophobic end) protruding from the matrix. Also in the various embodiments, the heterostructure nanofibers can comprise the end-to-end combination or joining of a silicon nanowire to a carbon nanotube, while the matrix can comprise an epoxy, resin, and/or liquid polymer.

In other aspects, the invention comprises an applied superhydrophobic or superhydrophilic (or superlipophobic, superlipophilic, superamphiphobic, or superamphiphilic) coating on a surface. Such coatings typically comprise a plurality of heterostructure nanofibers set within a matrix with each member of the plurality (or at least a majority of the members) having a hydrophobic end and a hydrophilic end and wherein one end of each member (or of at least a majority of the members) is set within the matrix and one end protrudes from the matrix. In different embodiments, the hydrophilic end of each member can be set within a matrix (comprised of an aqueous composition) or the hydrophobic end of each member can be set within a matrix (comprised of a nonaqueous composition). Also, in the various embodiments, the matrix can comprise a curable matrix (e.g., curable or settable through heat, UV, addition of setting compounds, drying, etc.). In various embodiments, each of the members (or at least a majority of such) can comprise one or more modification on either end (or on both ends). Such optional surface modifications can comprise, e.g., coatings on the nanofibers, moieties, or surface layers to alter or enhance hydrophobicity, hydrophilicity, and/or the stability of the nanofiber within the matrix. When present on both ends of the nanofibers, the surface modifications can differ on each end. In some embodiments, the heterostructure nanofibers herein comprise an end-to-end conjoined silicon nanowire and carbon nanotube. Also, in some embodiments, the matrix can comprise an epoxy, resin, polymer, or other cured matrix. The invention also includes surfaces (e.g., one or more metal, plastic, cloth, fiber, flexible surface, low-temperature surface, etc.) having the coatings of the invention.

In other aspects, the invention comprises a method of producing a hydrophobic or hydrophilic surface by applying any of the compositions of the invention to a surface, and, optionally, curing or setting the composition (e.g., through heating, drying, addition of a setting agent, UV, etc.).

In other aspects, the invention comprises methods of making the compositions of the invention by combining a plurality of heterostructure nanofibers and a matrix (e.g., a liquid matrix).

In yet other aspects, the invention comprises compositions having one or more nanofiber heterostructures that have a hydrophilic end (e.g., a silicon nanowire) and a hydrophobic end (e.g., a carbon nanotube) wherein one or both ends optionally comprises one or more surface application (e.g., coating, modification, etc.) such as a fluorinated compound on the hydrophobic end. The invention also includes surfaces (e.g., one or more metal, plastic, cloth, fiber, flexible surface, low-temperature surface, etc.) comprising such compositions.

These and other objects and features of the invention will become more fully apparent when the following detailed description is read in conjunction with the accompanying figures.

### BRIEF DESCRIPTION OF THE DRAWINGS

FIG. 1, displays a generalized schematic of an exemplary applied coating of the invention.

FIG. 2, Panels A and B, illustrates interaction of a liquid drop with a surface having a moderate contact angle and interaction of a liquid drop/surface with a high contact angle.

FIG. 3, schematically illustrates interaction of a liquid drop with an exemplary coating of the invention.

FIG. 4, Panels A through F, schematically illustrate surface modification of only part of nanofibers and their incorporation into an exemplary coating of the invention.

FIG. 5, displays a photograph of a lawn of silicon nanofibers (here nanowires) capable of use in the current invention.

FIG. 6, illustrates creation and utilization of Si nanowire-carbon nanotube heterostructures in coatings of the invention.

### DETAILED DESCRIPTION

In brief, the current invention comprises, inter alia, superhydrophobic coatings that can be applied to a wide range of surfaces (e.g., flexible surfaces, cloth, metal, ceramic, plastic, etc.) which render the surface superhydrophobic. Since the coatings can be applied to the surfaces after the nanofibers are created, the surfaces do not need to be exposed to the extreme conditions required to create the nanofibers.

The coatings herein comprise nanofiber heterostructures, typically (but not exclusively) having one end that is hydrophilic and one end that is hydrophobic. The nanofibers are mixed with a carrier matrix (e.g., a liquid matrix such as an epoxy or the like) that can be painted onto the surfaces where hydrophobicity is desired. The nanofiber heterostructures orient themselves so that their hydrophilic ends are set within the carrier matrix while their hydrophobic ends are sticking up from the matrix. Once the matrix is allowed to cure or set, a hydrophobic coating is thereby created. Additional embodiments comprising hydrophilic coatings (or lipophobic/lipophilic or amphiphobic/amphiphilic) are also included herein and described further below.

The use of coating materials to modify the hydrophobicity of surfaces offers an effective and attractive method to improve such aspects as the corrosion resistance, lifetime, and usability of a variety of surfaces. Previous traditional hydrophobic coating systems have depended on material such as plastics, waxes and Teflon® (e.g., various fluorination treatments). Recently, there has been a growing interest to construct hydrophobic surfaces by creating a “lotus leaf effect” where water forms nearly spherical shapes on a surface. Such work done by the inventor's co-worker (see, “Super-hydrophobic Surfaces, Methods of Their Construction And Uses Therefor,” U.S. patent application Ser. No. 10/833,944, filed Apr. 27, 2004) showed creation of superhydrophobic surfaces through use of nanofibers. Development of a coating that recreates this effect and which can be applied to surfaces that otherwise could not have nanofibers grown on them, opens the door to a variety of unique applications ranging from breathable, water-repellent uniforms, to water-repellent topcoats for sensitive field instruments, to novel toys, medical devices, drag reduction and corrosion resistance on ships, land vehicles, aircraft, instruments, and more.

As mentioned, prior work by the inventor and co-workers has developed and demonstrated innovative nanostructured surfaces constructed from nanofiber arrays or lawns that produce similar (and better) hydrophobicities as the natural micron-scale lotus leaf structure. Such surfaces have produced superhydrophobic behavior, with water droplet contact angles at nearly 180 degrees. In several such embodiments the nanofibers had diameters of 40 nm and lengths of about 50 um and were covered with a thin native oxide layer (e.g., silicon oxide) formed upon exposure of the nanofibers to air. In their native state, the nanofiber array would exhibit superhydrophilic behavior (very homogenous wetting across the surface), but by treating the surface with a hydrophobic fluorination agent (or other agent), the surface was rendered superhydrophobic with water contact angles of nearly 180 degrees. Such superhydrophobic results have been constructed on a variety of substrates including planar silicon wafers, metals (titanium, aluminum, and stainless steel), ceramics, quartz and standard glass. Optically transparent versions of the nanofiber surfaces were also demonstrated by converting the silicon nanowires to an oxide.

Prior work by the inventor and coworkers has also produced superhydrophobic woven surfaces. In such instances, a woven mat of 25 um diameter fibers with 75 um openings, containing gold catalysts, was placed in a CVD reactor to grow nanofibers. Nanofibers formed a dense highly porous open frame fiber network or bird's nest structure. Within the network, the nanowires occupied less than 1% of the total pore volume and were spatially separated on the nanometer scale. Thus, such network created a “non-tortuous path” to expediently and freely allow air and moisture vapor to diffuse, while exhibiting water contact angles of greater than 170 degrees for bulk liquids. Superhydrophobic results for such woven mat also demonstrated extreme water moisture permeability of >20x over Gore-tex®. A comparison between such superhydrophobic woven mat and Gore-tex® also showed pore size differences (2.3 um mat versus 0.2 um Gore-tex®), hydro-head (417 cm mat versus 1,000 cm Gore-tex®), and moisture vapor (>100,000 g/m/24 hours mat versus 5,000 g/m/24 hours Gore-tex®). An applied superhydrophobic coating which demonstrates similar characteristics, but which can be painted onto fabrics/textiles, low temperature plastics, etc. is a feature of the current invention.

While the superhydrophobic surfaces constructed by the inventor and co-workers are quite useful, the process to create superhydrophobic surfaces relies on the formation of the required surface morphology through the direct growth of the nanofiber structures in growth reactor chambers. Since such reactors require high temperatures (greater than 200° C.) and can have limited size capacity (often less than 8 inch square), production can be prohibited for a number of applications. As a result, as explained above, the current invention produces novel nano-engineered nanofiber heterostructure coatings which can be applied at room temperature and which recreate the required nanostructured morphology needed to achieve extreme superhydrophobicity on surfaces.

The basis of the current invention comprises a heterostructure nanofiber that contains both hydrophobic and hydrophilic segments or regions. In brief, after synthesis, the heterostructure is harvested off of its growth substrate and then suspended in a matrix (e.g., an epoxy), which can serve as a paintable coating medium and a binder. The nanofiber/matrix mixture can then be applied to a substrate. Due to the unique opposite chemistries of the segments of the nanofibers, each one (or a majority of them) will self-phase segregate or partition into their respective air and liquid/binder phases. That is, the hydrophilic end of each nanofiber will go into the matrix binder and the hydrophobic segment will go toward the air. In this way, the surface morphology that is needed to achieve superhydrophobicity is created in the process. After phase segregation, the matrix can be cured by UV light, chemicals, etc., to achieve adhesion to the substrate and to set the nanofibers.

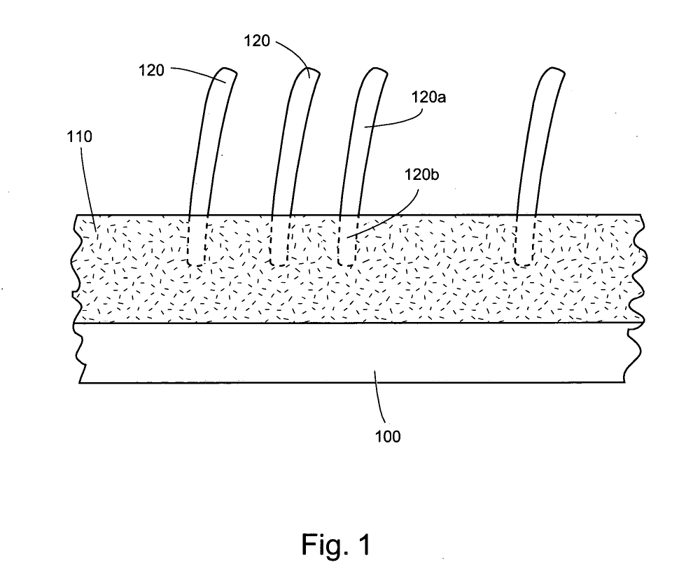

FIG. 1 shows a schematic of a plurality of exemplary heterostructures of the invention within a coating matrix. As can be seen, members 120 of the plurality protrude partway from the surface of coating matrix 110 which is applied upon surface 100. The protruding nanofibers produce a surface morphology that, in combination with optional modifications to the nanofibers, produces superhydrophobicity, superhydrophilicity, superlipophobicity, superlipophilicity, superamphiphobicity, or superamphiphilicity.

As explained herein, depending upon the particular embodiment, the nanofiber heterostructures can comprise myriad different constructions. Such constructions often fall into two categories however. In one category, the nanofibers comprise a single core structure (e.g., a silicon nanowire) that has different hydrophobic or lipophobic aspects on each end. For example, in FIG. 1, if the matrix layer is an aqueous or hydrophilic matrix, then portion 120b of each nanofiber member will also typically be hydrophilic or comprise moieties or surface modifications of the base nanofiber to make it hydrophilic. Correspondingly, portion 120a, which protrudes from the matrix layer will typically be hydrophobic or comprise moieties or surface modifications of the base nanofiber to make it hydrophobic. In another category of nanofibers, the nanofibers comprise two different core compositions, e.g., a silicon nanowire and a carbon nanotube (see, e.g., Lieber et al., 1999, Nature, 399:48-51). Each section of such dual nature nanofibers can comprise an inherent hydrophobicity/hydrophilicity, etc., and can also optionally be modified (e.g., with specific moieties, etc.) similar to the single core structures previously described. It will be appreciated that FIG. 1, as well as the other figures herein, is for illustrative purposes only and, thus, specific nanofiber shapes, densities, depth of insertion into the matrix, etc., should not necessarily be taken as limiting.

It will be appreciated that by having a matrix layer that is hydrophobic, that superhydrophilic surface coatings can be constructed. Thus, in such embodiments the hydrophobic ends of the nanofibers will self-segregate into the hydrophobic matrix layer, while the hydrophilic ends will self-segregate into the air (or outside of the hydrophobic matrix).

Definitions

Before describing the present invention in detail, it is to be understood that this invention is not limited to particular configurations, which can, of course, vary (e.g., different combinations of heterostructures and modifications, etc. which are optionally present in a range of lengths, densities, etc.). It is also to be understood that the terminology used herein is for the purpose of describing particular embodiments only, and is not intended to be limiting. As used in this specification and the appended claims, the singular forms “a,” “an,” and “the” include plural referents unless the context clearly dictates otherwise. Thus, for example, reference to “a nanofiber heterostructure” optionally includes a plurality of such nanofiber heterostructures, and the like.

The examples of the invention and description of particular embodiments herein are not necessarily intended to otherwise limit the scope of the present invention in any way. Indeed, for the sake of brevity, conventional nanofiber manufacturing, and nanofiber (and nanowire, nanorod, nanotube, and nanoribbon, etc.) technologies and other functional aspects of the construction of the individual components of the nanofibers are not necessarily described in detail herein. Furthermore, for purposes of brevity, the invention is frequently described herein as pertaining to nanofibers or more specifically to nanofiber heterostructures. Of course, it will be appreciated that such general language is not necessarily limiting and that, thus, the invention comprises heterostructures comprising nanowires, nanorods, nanotubes, etc.

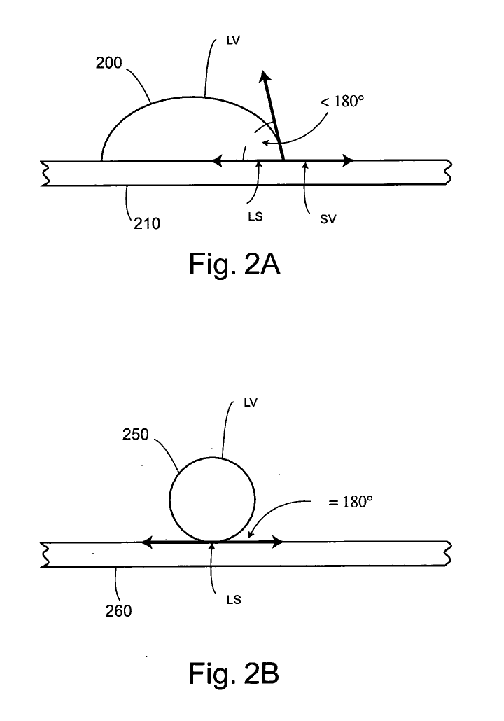

“Hydrophobic” refers to the characteristic of a material to repel water or aqueous fluid, while “lipophobic” refers to the characteristic of a material to repel nonaqueous fluids. “Amphiphobic” describes the characteristic of a material which is both hydrophobic and lipophobic and thus repels both lipid and non-lipid or aqueous/water-based liquids. Such materials repel liquids, e.g., by causing the liquid to bead-up on the material's surface and not spread out or wet the material's surface. See FIG. 2.

“Superhydrophobicity,” “superlipophobicity,” and “superamphiphobicity,” all refer to properties of substances which cause a liquid drop on their surface to have a contact angle of 150° or greater. See FIG. 2. It should be noted that while the invention is primarily described in terms of hydrophobic or superhydrophobic coatings, etc., depending on the specific embodiment, the coatings and the like can comprise superlipophobic or superamphiphobic coatings as well. Thus, when an embodiment herein is discussed in terms of superhydrophobicity, it should be understood that the invention also includes similar embodiments having superlipophobicity and embodiments having superamphiphobicity unless specifically stated otherwise. Thus, depending upon context, the liquid drop can comprise, e.g., a water/water based/aqueous drop (superhydrophobicity), a lipid based drop (superlipophobicity), a water based or lipid based drop (superamphiphobicity), or other liquids.

As used herein, a “nanostructure” (often referred to herein simply as a “nanofiber”) is a structure having at least one region or characteristic with a dimension of less than about 500 nm, e.g., less than about 200 nm, less than about 100 nm, less than about 50 nm, or even less than about 20 nm. Typically, the region or characteristic dimension will be along the smallest axis of the structure. Examples of such structures include nanowires, nanorods, nanotubes, nanotetrapods, tripods, bipods, branched tetrapods (e.g., inorganic dendrimers), and the like. Nanofibers herein will typically be heterogeneous (e.g., heterostructures). Additionally, nanofibers can be, for example, substantially crystalline, substantially monocrystalline, polycrystalline, amorphous, or a combination thereof. Nanofibers can have a variable diameter or can have a substantially uniform diameter, that is, a diameter that shows a variance less than about 20% (e.g., less than about 10%, less than about 5%, or less than about 1%) over the region of greatest variability and over a linear dimension of at least 5 nm (e.g., at least 10 nm, at least 20 nm, or at least 50 nm). Typically the diameter is evaluated away from the ends of the nanofiber (e.g. over the central 20%, 40%, 50%, or 80% of the nanofiber). A nanofiber can be straight or can be e.g. curved or bent, over the entire length of its long axis or a portion thereof. In certain embodiments, a nanofiber or a portion thereof can exhibit two- or three-dimensional quantum confinement. Nanofibers according to this invention can include carbon nanotubes, and, in certain embodiments, “whiskers” or “nanowhiskers,” e.g., even whiskers having a diameter greater than 100 nm, or greater than about 200 nm. Examples of such nanofibers include semiconductor nanowires as described in Published International Patent Application Nos. WO 02/17362, WO 02/48701, and WO 01/03208, carbon nanotubes, and other elongated conductive or semiconductive structures of like dimensions, which are incorporated herein by reference.

Although the term “nanofiber” is referred to herein in general, the description is for illustrative purposes. It is intended that the description encompass use of nanostructures such as nanowires, nanorods, nanotubes, nanotetrapods, nanoribbons and/or combinations thereof. Nanotubes (e.g., nanowire-like structures having a hollow tube formed axially therethrough) are also included.

As used herein, the term “nanowire” generally refers to any elongated conductive or semiconductive material (or other material described herein) that includes at least one cross sectional dimension that is less than 500 nm, and preferably, less than 100 nm, and has an aspect ratio (length:width) of greater than 10, preferably greater than 50, and more preferably, greater than 100, or greater than 1000.

As used herein, the term “nanorod” generally refers to any elongated conductive or semiconductive material (or other material described herein) similar to a nanowire, but having an aspect ratio (length:width) less than that of a nanowire. Note that two or more nanorods can be coupled together along their longitudinal axis.

As used herein, an “aspect ratio” is the length of a first axis of a nanostructure divided by the average of the lengths of the second and third axes of the nanostructure, where the second and third axes are the two axes whose lengths are most nearly equal to each other. For example, the aspect ratio for a perfect nanowire would be the length of its long axis divided by the diameter of a cross-section perpendicular to (normal to) the long axis.

The term “heterostructure” when used with reference to nanostructures herein refers to structures characterized by at least two different and/or distinguishable material types or regions. For example, one region of the nanostructure can comprise a first material type, while a second region of the nanostructure can comprise a second material type. In various embodiments, the different material types are distributed at different locations within or along the nanostructure, e.g., along the major (long) axis of a nanostructure such as with Si-nanowire/carbon nanotubes. Different regions within a heterostructure can comprise entirely different materials, or the different regions can comprise a similar base material or core that comprises different constituents or moieties at different locations upon the base material, e.g., to produce hydrophobic ends, etc.

A wide range of types of materials for nanofibers (e.g., nanowires, nanorods, nanotubes and nanoribbons) can be used, including semiconductor material selected from, e.g., Si, Ge, Sn, Se, Te, B, C (including diamond), P, B-C, B-P(BP6), B-Si, Si-C, Si-Ge, Si-Sn and Ge-Sn, SiC, BN/BP/BAs, AlN/AlP/AlAs/AlSb, GaN/GaP/GaAs/GaSb, InN/InP/InAs/InSb, BN/BP/BAs, AlN/AlP/AlAs/AlSb, GaN/GaP/GaAs/GaSb, InN/InP/InAs/InSb, ZnO/ZnS/ZnSe/ZnTe, CdS/CdSe/CdTe, HgS/HgSe/HgTe, BeS/BeSe/BeTe/MgS/MgSe, GeS, GeSe, GeTe, SnS, SnSe, SnTe, PbO, PbS, PbSe, PbTe, CuF, CuCl, CuBr, CuI, AgF, AgCl, AgBr, AgI, BeSiN2, CaCN2, ZnGeP2, CdSnAs2, ZnSnSb2, CuGeP3, CuSi2P3, (Cu, Ag)(Al, Ga, In, Tl, Fe)(S, Se, Te)2, Si3N4, Ge3N4, Al2O3, (Al, Ga, In)2 (S, Se, Te)3, Al2CO, and an appropriate combination of two or more such semiconductors.

The nanostructures herein can also be formed from other materials such as metals (e.g., gold, nickel, palladium, iradium, cobalt, chromium, aluminum, titanium, ruthenium, tin and the like), metal alloys, polymers, conductive polymers, ceramics, and/or combinations thereof. Other now known or later developed conducting or semiconductor materials can also be employed.

In certain aspects, the nanofibers can comprise a dopant from a group consisting of: a p-type dopant from Group m of the periodic table; an n-type dopant from Group V of the periodic table; a p-type dopant selected from a group consisting of: B, Al and In; an n-type dopant selected from a group consisting of: P, As and Sb; a p-type dopant from Group II of the periodic table; a p-type dopant selected from a group consisting of: Mg, Zn, Cd and Hg; a p-type dopant from Group IV of the periodic table; a p-type dopant selected from a group consisting of: C and Si.; or an n-type dopant selected from a group consisting of: Si, Ge, Sn, S, Se and Te. Other now known or later developed dopant materials can also be employed.

Additionally, the nanofibers herein can include carbon nanotubes, or nanotubes formed of conductive or semiconductive organic polymer materials, (e.g., pentacene and transition metal oxides).

Measurement of Hydrophobicity

Certain plant leaves, such as the sacred lotus (Nelumbo nucifera), display natural superhydrophobic behavior. This effect is caused by both the hierarchical roughness of the leaf surface, which has a large ratio of geometric surface area to projected area, and an intrinsic surface layer epicuticular wax covering. This construction results in a greater energy barrier to create a lipid solid interface, thereby allowing water drops to literally rest on trapped air. The degree of hydrophobicity is determined through contact angle measurements. When a droplet of water is applied to a surface, the contact angle is defined as the tangent angle between the surface material and the droplet at the point of contact. See FIG. 2, which shows liquid drop 200, on non-superhydrophobic surface 210, and liquid drop 250 on superhydrophobic surface 260.

When a drop of a liquid (e.g., water based, lipid based, etc.) rests upon a surface, it will spread out over the surface based upon such factors as the surface tensions of the liquid and the type of substrate, e.g., the smoothness or roughness of the surface, etc. For example, the hydrophobicity of a substrate can be increased by various coatings that lower the surface energy of the substrate. The quantification of hydrophobicity can be expressed as the degree of contact surface angle (or contact angle) of the drop of the liquid on the surface.

For example, for a surface having a high surface tension (i.e., higher than the surface tension of the liquid drop), a drop of liquid will spread out “wetting” the surface of the substrate. Such surface displays hydrophilicity, as opposed to hydrophobicity. In instances where the contact angle is greater than zero (e.g., where the surface displays a greater degree of hydrophobicity), the relationship of the surface tension (γ) and the contact angle (θ) is shown by Young's equation:

$$cos θ = \frac{( {γ}_{SV} - {γ}_{SL} )}{{γ}_{LV}} \qquad ( 1 )$$

where γ_{SV}, γ_{SL}, and γ_{LV} are the surface energies (i.e., the interstitial free energies per unit area) of the solid/vapor, solid/liquid and liquid/vapor interfaces respectfully, and θ is the contact angle between the liquid drop and the substrate surface. Thus, when the surface energy is decreased, hydrophobicity is increased (and vice versa). For smooth surfaces, maximum contact angles of around 120° have been achieved for CF₃-terminated substrates.

Surfaces having contact angles of 150° and above are described as superhydrophobic. When the liquid is not aqueous based, the action is typically described in terms of superlipophobicity or superamphiphobicity (where the liquid can be either a lipid or non-lipid).

In order to get release of a liquid from a substrate, the surface of the substrate should have a lower critical surface tension than that of the liquid in question. In general, many liquids have a critical surface tension greater than 20 dynes/cm. For example, deionized water at 20° C. has a critical surface tension of 73 dynes/cm, while DMSO is 25 dynes/cm, and toluene is 28 dynes/cm. Examples of exemplary critical surface tensions of smooth surfaced substrates include soda glass at 30 dynes/cm, 301 stainless steel at 44 dynes/cm, and Teflon® at 18 dynes/cm.

Young's equation above is applicable when the substrate surface is smooth. However, when the substrate surface is rough, then such roughness must be taken into account in determining the contact angle. Thus, Wenzel's equation:
cosθ′=r(γ_{SV}−γ_{SL})/γ_{LV}=rcosθ (2)
is used to determine contact angle. In this equation ‘r’ represents the ‘roughness factor’ of the surface and is defined as the ratio of the actual area of a surface compared to the expected geometric area of the surface. Wenzel's equation can also be written as:
cosθ_{W}=rcosθ_{Y} (3)
where θ_{W} is the Wenzel angle and θ_{Y} is the Young angle. It should be noted that the roughness in Wenzel's analysis is quite small in nature and is not so great as to form voids between the substrate and the liquid.

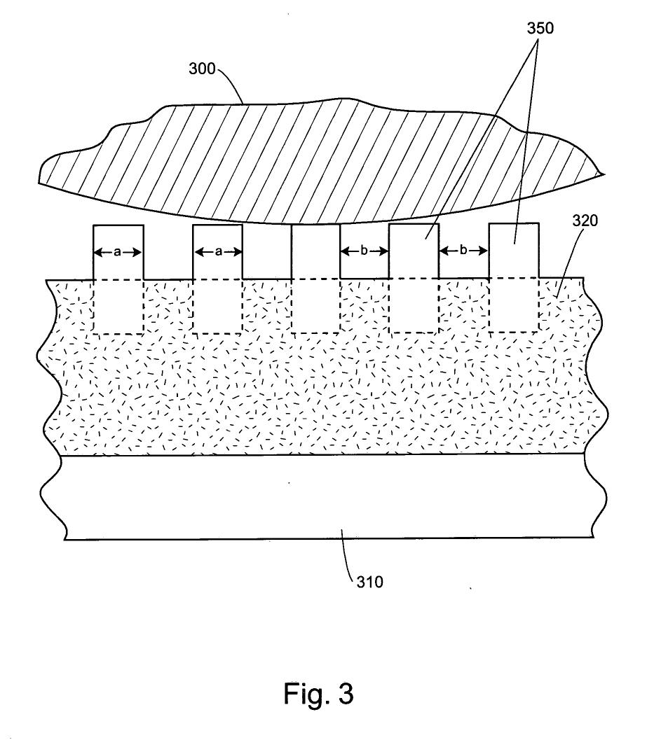

However, for surfaces that are rough enough so that air does become trapped between the substrate surface and the liquid (thus, forming a composite interface), Cassie's equation is used. In Cassie's equation, the contact angle is determined by:
cosθ′=ƒcosθ+(1−ƒ)cos180°=ƒcosθ+ƒ−1 (4)
where θ′ represents the contact angle between the liquid and the air/substrate surface. In the equation, an air/liquid contact angle of 180° is assumed. Also, in the equation, ƒequals Σₐ/Σ(a+b), the solid surface area fraction (i.e., the area ‘a’ being the area of contact between the substrate surface and the liquid and the area ‘b’ being the area of contact between the liquid and the air trapped in between the liquid and the substrate). See FIG. 3, which shows a schematic which illustrates the interaction of liquid drop 300 with heterostructures 350 embedded in matrix 320 applied onto substrate 310. As can be seen, the liquid drop rests on the nanofibers and is thus held above trapped air spaces. Cassie's equation can be rearranged to become
cosθ_{CB}=ƒ_{SL}cosθ_{Y}−ƒ_{LA} (5)
where ƒ_{SL} is the fractional coverage of the solid/liquid interface and ƒ_{LA} is the fractional coverage of the liquid/air interface.

It will be appreciated that in such analysis the depth of the roughness on the surface is not a factor in determining the contact angle. However, the width or amount of the “points” of the substrate that touch the liquid and the width between such points (i.e., the width of the liquid/air contact “points”) is of importance. The increased surface roughness provides a large geometric area for a relatively small geographic area on the substrate. Similar surface roughness on the leaves of the sacred lotus can lead to a naturally occurring superhydrophobicity (contact angle of approximately 170° in some instances). As explained in more detail below, such roughness in the above equations includes nanofibers, e.g., present in the coatings of the present invention.

Those of skill in the art will be familiar with various means to measure the contact angle of various liquids on surfaces, e.g., with an optical contact angle meter, etc. Other measurements of superhydrophobicity include sliding angle, e.g., the degree of angle or tilt of a substrate for a liquid drop to slide or move about on the substrate. The superhydrophobic surfaces herein can display a sliding angle of 5° or less, of 4° or less, of 3° or less, of 2° or less, or even of 1° or less. Again, those of skill in the art will be quite familiar with such concepts and the necessary measurements needed.

Heterostructures

In various embodiments, the nanofiber heterostructures of the invention comprise at least one area or region that is hydrophobic and at least one area or region that is hydrophilic. See FIG. 1. Thus, in particular embodiments the hydrophilic end will naturally segregate into an aqueous coating matrix, while the hydrophobic end will naturally segregate outside of the coating matrix. Those of skill in the art will appreciate, however, that myriad permutations exist in such basic outline. For example, the heterostructures can comprise structures that have two different constructions that are joined together (e.g., as in the silicon nanowire-carbon nanotube constructs below). In other embodiments, the heterostructures can comprise a single core structure (e.g., a silicon nanowire) that is modified on one end to be hydrophobic and/or on the other end to be hydrophilic. In yet other embodiments, the heterostructures can comprise nanostructures that have more than two ends, e.g., triads, crosses, various branched nanofibers, etc. In such configurations, at least one end or region will be hydrophobic and at least one end or region will be hydrophilic to allow for natural segregation as explained throughout.

The nanofibers of the invention are optionally constructed through a number of different methods, and the examples and discussion listed herein should not necessarily be taken as limiting. Thus, nanofibers constructed through means not specifically described herein, but which produce a heterostructure comprising a hydrophobic and/or hydrophilic end and which fall within the superhydrophobic, etc., parameters as set forth herein are still nanofibers of the invention.

In a general sense, and as described previously, the nanofibers of the current invention typically comprise long thin protuberances, e.g., fibers or wires, or even rods, cones, tubes, or the like (or any combinations thereof), that are detached from the substrate on which they are grown and mixed with a carrier matrix.

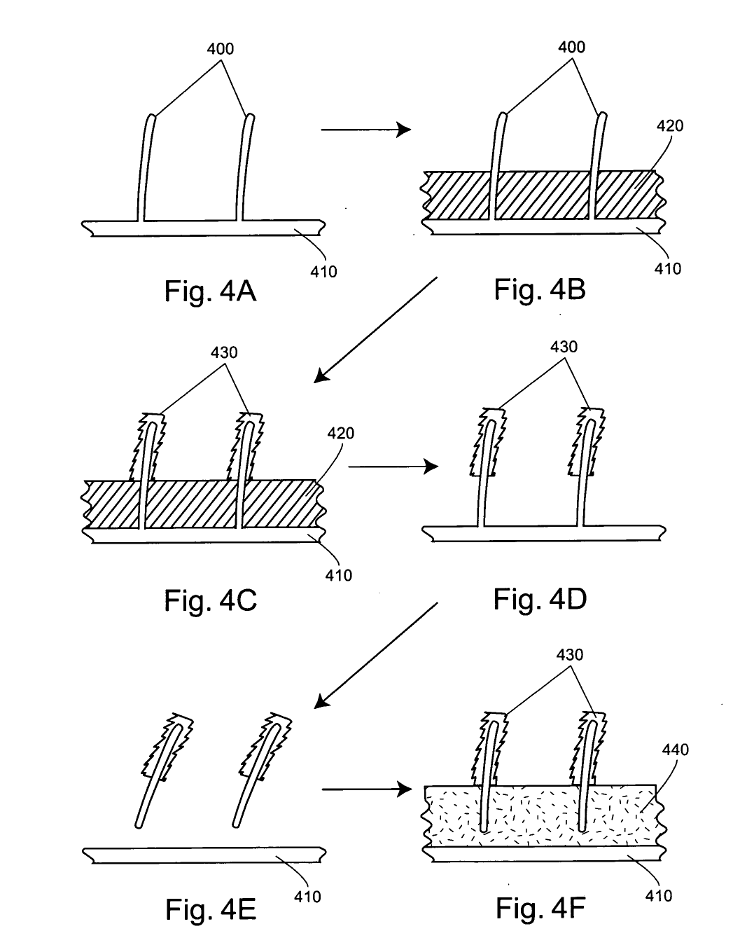

FIG. 4 gives a rough cartoon representation of exemplary nanofibers of the invention. In Panel A, the nanofibers are attached to the substrate surface prior to “harvest” or separation. Again, it will be appreciated that FIG. 4 is merely for illustrative purposes and should not necessarily be taken as limiting. For example, the length, diameter, density, shape, composition, etc. of the nanofibers of the invention are all optionally quite diverse and can be different in the various embodiments. See below. Additionally, as will be appreciated, the surface modifications to the nanofibers are optionally quite variable as well. Thus, the thickness, composition, application time, and degree of surface modifications of the nanofibers (e.g., whether the entire nanofiber is modified, whether only the tip of the nanofiber is modified, etc.) can all optionally vary from embodiment to embodiment in the invention.

As can be seen, the nanofibers herein can comprise a single fiber of an inorganic material (typically, but not exclusively silicon and/or a silicon oxide) around which or upon which is disposed a hydrophobic (or hydrophilic, etc.) surface modification for at least part of the area of the nanofiber. The modification is optionally comprised of any of a number of hydrophobic, lipophobic and/or amphiphobic materials. See below. The actual modification used can be chosen based on a number of variables such as: cost, ease of use, the liquid that will come into contact with the nanofibers, durability, opaqueness, adhesion of the modification to the core of the nanofibers, shape/density/etc. of the nanofibers, the type of carrier matrix to be used, etc. “Exogenous” in such situations typically indicates that the modification is not part of the “core” nanofiber (e.g., is not initially constructed as part of the nanofiber). Such modifications are typically applied after the nanofibers are grown and can comprise a “sheath” or “envelope” layer around the nanofiber core for at least part of its length. However, as further described below, such modifications optionally can be modifications of the material of the core of the nanofiber. Thus, a major benefit of the current invention is the adaptability and ease of tailoring of the invention to specific uses and conditions. For example, depending upon such factors as the type of liquids to be encountered, durability, toxicity, cost, etc. different coatings can be used on the nanofibers. Also, although described as a sheath or coating, it will be appreciated that such treatment will not always comprise a uniform or homogeneous layer or coating over an entire core area of the nanofiber, but can, in some instances, be amorphously, periodically or regionally deposited over the nanofiber surfaces or over a region of the nanofiber surface.

As is explained in more detail below, numerous hydrophobic, hydrophilic, etc., surface modifications are well known to those of skill in the art. It will be appreciated that the invention is not necessarily limited by a specific exogenous hydrophobic modifications and the listing herein of specific examples of such should not be necessarily construed as limiting.

Application of the modification material to the core nanofibers can be accomplished in various ways depending upon the specific needs of the material and of the nanofibers, etc. In other words, different hydrophobic/hydrophilic materials are attached to different nanofibers in different ways. Binding, depositing, etc. of hydrophobic/hydrophilic materials to materials such as silicon (e.g., of which the core nanofibers are often constructed) is well known to those of skill in the art. See, e.g., U.S. Pat. No. 5,464,796 to Brennan, and Arkles, “Silane Coupling Agent Chemistry,” Application Note, United Chemical Technologies, Inc. Bristol, Pa. Thus, surface chemical modifications of nanofibers (e.g., of silicon nanofibers) also can create an exogenous modification on the nanofiber. Embodiments exist herein wherein the modification is not a layer on the core per se, but rather is a modification/addition to the surface of the core, e.g., a change of the surface molecules of the core or an addition of other molecules to the surface molecules of the core nanofiber.

Additionally, as stated previously, the modification material on the nanofiber cores need not entirely cover the nanofibers of the invention in all embodiments. For example, as shown in FIG. 4, in some embodiments nanofibers 400 (e.g., silicon nanowires) are optionally grown on surface 410. The lawn of nanofibers can then be partially covered with protectant 420 so that only the tips or top halves of the nanowires protrude from the protectant. The unprotected ends can then be modified, e.g., to become hydrophobic ends 430. The protectant can then be removed, thus, exposing the unmodified ends of the nanowires and the resulting heterostructures can be harvested (Panel E) for use in the current invention, e.g., mixed with matrix 440 and allowed to self segregate, etc. (Panel F).

Construction of Nanofiber Heterostructures

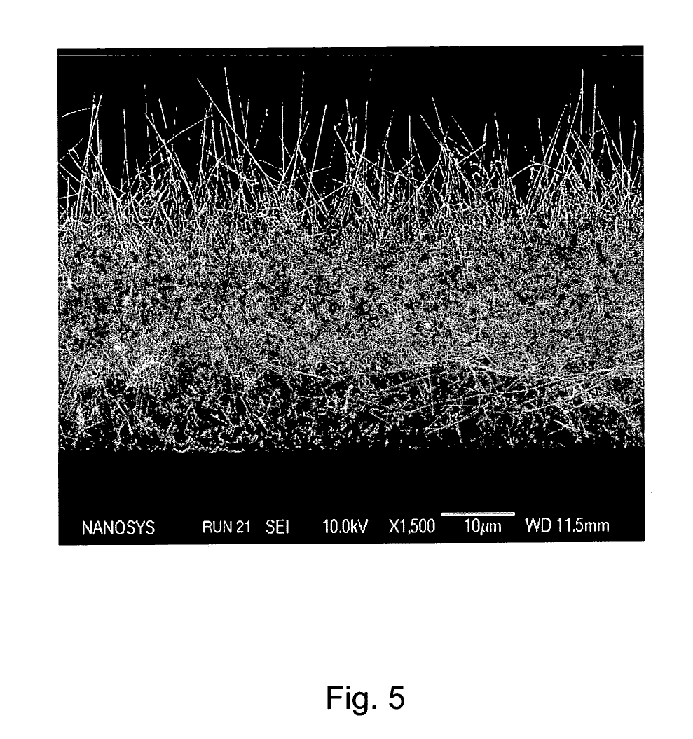

As will be appreciated, the current invention is not necessarily limited by the means of construction of the nanofiber heterostructures herein. In certain embodiments, the nanofibers herein can be composed of an inorganic material, such as silicon and/or silicon oxides and can be solid, crystalline structures. See FIG. 5, which shows a lawn of silicon nanofibers (here nanowires) capable of use in the current invention. In other embodiments the nanofibers herein can comprise carbon nanotubes, while in yet other embodiments the nanofibers can comprise linearly conjoined structures (e.g., silicon nanowire joined end to end with a carbon nanotube). The formation of nanofibers is possible through a number of different approaches that are well known to those of skill in the art, all of which are amenable to the current invention. See, e.g., U.S. Pat. Nos. 5,230,957; 5,537,000; 6,128,214; 6,225,198; 6,306,736; 6,314,019; 6,322,901; 6,501,091; and published International Patent Application Nos. WO 02/17632 and WO 01/03208, the full disclosures of each of which are hereby incorporated herein by reference in their entirety for all purposes.

Thus, embodiments herein can be created from various methods of nanostructure fabrication, as will be known by those skilled in the art, as well as methods mentioned or described herein. For example, the various nanofibers herein can be made by the methods mentioned or described herein or via other methods. In other words, a variety of methods for making nanofibers and nanofiber containing structures exist, have been described, etc. and can be adapted for use in various of the methods, compositions, and surfaces of the invention.

As described above, various heterostructures herein can comprise a core nanofiber (e.g., nanowire, etc.) that is modified differently at each end (e.g., it comprises hydrophobic modifications at one end such as addition of a fluorinated compound and naturally occurring hydrophilicity or hydrophilic modifications at the other end). Other embodiments can comprise heterostructures created by the combination of two or more different nanofiber cores (e.g., silicon nanowire and carbon nanotube) which each comprises different hydrophobicities (and/or which can also comprise surface modifications as well). See below.

The nanofibers can be fabricated of essentially any convenient material (e.g., a semiconducting material, a ferroelectric material, a metal, etc.) within the current parameters and can comprise essentially a single material or can be mixtures of materials. For example, the nanofibers can comprise a semiconducting material, for example a material comprising a first element selected from group 2 or from group 12 of the periodic table and a second element selected from group 16 (e.g., ZnS, ZnO, ZnSe, ZnTe, CdS, CdSe, CdTe, HgS, HgSe, HgTe, MgS, MgSe, MgTe, CaS, CaSe, CaTe, SrS, SrSe, SrTe, BaS, BaSe, BaTe, and like materials); a material comprising a first element selected from group 13 and a second element selected from group 15 (e.g., GaN, GaP, GaAs, GaSb, InN, InP, InAs, InSb, and like materials); a material comprising a group 14 element (Ge, Si, and like materials, such as, e.g., SiC or SiN); a material such as PbS, PbSe, PbTe, AlS, AlP, and AlSb; or an alloy or a mixture thereof.

Some embodiments herein can comprise nanofibers of titanium oxides or of mixtures of titanium oxide(s) and other material. Such mixtures can comprise differing percentages of titanium oxide(s), e.g., from 1% or less to about 20%, from about 2% or less to about 15%, from about 3% or less to about 10%, or from about 4% or less to about 5%.

In certain embodiments herein, the nanofibers are optionally comprised of silicon or silicon oxide. It will be understood by one of skill in the art that the term “silicon oxide” as used herein can be understood to refer to silicon at any level of oxidation. Thus, the term silicon oxide can refer to the chemical structure SiOₓ, wherein x is between 0 and 2 inclusive. Common methods for making silicon nanofibers include vapor liquid solid growth (VLS), laser ablation (laser catalytic growth) and thermal evaporation. See, for example, Morales et al. (1998) “A Laser Ablation Method for the Synthesis of Crystalline Semiconductor Nanowires” Science 279, 208-211 (1998).

In general, numerous methods of making nanofibers and other nanostructures have been described and can be applied in the methods, compositions and surfaces herein. In addition to Morales et al. (above), See, for example, Lieber et al. (2001) “Carbide Nanomaterials” U.S. Pat. No. 6,190,634 B1; Lieber et al. (2000) “Nanometer Scale Microscopy Probes U.S. Pat. No. 6,159,742; Lieber et al. (2000) “Method of Producing Metal Oxide Nanorods” U.S. Pat. No. 6,036,774; Lieber et al. (1999) “Metal Oxide Nanorods” U.S. Pat. No. 5,897,945; Lieber et al. (1999) “Preparation of Carbide Nanorods” U.S. Pat. No. 5,997,832; Lieber et al. (1998) “Covalent Carbon Nitride Material Comprising C₂N and Formation Method; Thess, et al. (1996) “Crystalline Ropes of Metallic Carbon Nanotubes” Science 273, 483-486; Lieber et al. (1993) “Method of Making a Superconducting Fullerene Composition By Reacting a Fullerene with an Alloy Containing Alkali Metal” U.S. Pat. No. 5,196,396, and Lieber et al. (1993) “Machining Oxide Thin Films with an Atomic Force Microscope: Pattern and Object Formation on the Nanometer Scale” U.S. Pat. No. 5,252,835. Recently, one-dimensional semiconductor heterostructure nanocrystals, have been described. See, e.g., Bjork et al. (2002) “One-dimensional Steeplechase for Electrons Realized” Nano Letters Vol. 2:86-90.

It should be noted that some references herein, while not necessarily specific to nanofibers, are optionally still applicable to the invention. For example, background issues of construction conditions and the like are applicable between nanofibers and other nanostructures. Also some nanostructures, e.g., nanocrystals, etc. can be, in some embodiments, optionally comprised within the coatings of the invention (e.g., in addition to the nanofibers). Synthesis of nanostructures, e.g., nanocrystals, of various composition is described in, e.g., Peng et al. (2000) “Shape control of CdSe nanocrystals” Nature 404:59-61; Puntes et al. (2001) “Colloidal nanocrystal shape and size control: The case of cobalt” Science 291:2115-2117; U.S. Pat. No. 6,306,736 to Alivisatos et al. (Oct. 23, 2001) entitled “Process for forming shaped group III-V semiconductor nanocrystals, and product formed using process”; U.S. Pat. No. 6,225,198 to Alivisatos et al. (May 1, 2001) entitled “Process for forming shaped group II-VI semiconductor nanocrystals, and product formed using process”; U.S. Pat. No. 5,505,928 to Alivisatos et al. (Apr. 9, 1996) entitled “Preparation of III-V semiconductor nanocrystals”; U.S. Pat. No. 5,751,018 to Alivisatos et al. (May 12, 1998) entitled “Semiconductor nanocrystals covalently bound to solid inorganic surfaces using self-assembled monolayers”; U.S. Pat. No. 6,048,616 to Gallagher et al. (Apr. 11, 2000) entitled “Encapsulated quantum sized doped semiconductor particles and method of manufacturing same”; and U.S. Pat. No. 5,990,479 to Weiss et al. (Nov. 23, 1999) entitled “Organo luminescent semiconductor nanocrystal probes for biological applications and process for making and using such probes.”

In a general approach, synthetic procedures to prepare individual nanostructures on surfaces and in bulk are described, for example, by Kong, et al. (1998) “Synthesis of Individual Single-Walled Carbon Nanotubes on Patterned Silicon Wafers,” Nature 395, 878-881, and Kong, et al. (1998), “Chemical Vapor Deposition of Methane for Single-Walled Carbon Nanotubes” Chem. Phys. Lett. 292, 567-574. In yet another approach, substrates and self assembling monolayer (SAM) forming materials can be used, e.g., along with microcontact printing techniques to make nanofibers, such as those described by Schon, Meng, and Bao, “Self-assembled monolayer organic field-effect transistors,” Nature 413:713 (2001); Zhou et al. (1997) “Nanoscale Metal/Self-Assembled Monolayer/Metal Heterostructures,” Applied Physics Letters 71:611; and WO 96/29629 (Whitesides, et al., published Jun. 26, 1996).

Growth of nanofibers, such as nanowires, having various aspect ratios, including nanowires with controlled diameters, is described in, e.g., Gudiksen et al. (2000) “Diameter-selective synthesis of semiconductor nanowires” J. Am. Chem. Soc. 122:8801-8802; Cui et al. (2001) “Diameter-controlled synthesis of single-crystal silicon nanowires” Appl. Phys. Lett. 78: 2214-2216; Gudiksen et al. (2001) “Synthetic control of the diameter and length of single crystal semiconductor nanowires” J. Phys. Chem. B 105:4062-4064; Morales et al. (1998) “A laser ablation method for the synthesis of crystalline semiconductor nanowires” Science 279:208-211; Duan et al. (2000) “General synthesis of compound semiconductor nanowires” Adv. Mater. 12:298-302; Cui et al. (2000) “Doping and electrical transport in silicon nanowires” J. Phys. Chem. B 104:5213-5216; Peng et al. (2000), supra; Puntes et al. (2001), supra; U.S. Pat. No. 6,225,198 to Alivisatos et al., supra; U.S. Pat. No. 6,036,774 to Lieber et al. (Mar. 14, 2000) entitled “Method of producing metal oxide nanorods”; U.S. Pat. No. 5,897,945 to Lieber et al. (Apr. 27, 1999) entitled “Metal oxide nanorods”; U.S. Pat. No. 5,997,832 to Lieber et al. (Dec. 7, 1999) “Preparation of carbide nanorods”; Urbau et al. (2002) “Synthesis of single-crystalline perovskite nanowires composed of barium titanate and strontium titanate” J. Am. Chem. Soc., 124, 1186; Yun et al. (2002) “Ferroelectric Properties of Individual Barium Titanate Nanowires Investigated by Scanned Probe Microscopy” Nano Letters 2, 447; and published PCT application Nos. WO 02/17362, and WO 02/080280.

Growth of branched nanostructures (e.g., nanotetrapods, tripods, bipods, and branched tetrapods) is described in, e.g., Jun et al. (2001) “Controlled synthesis of multi-armed CdS nanorod architectures using monosurfactant system” J. Am. Chem. Soc. 123:5150-5151; and Manna et al. (2000) “Synthesis of Soluble and Processable Rod-, Arrow-, Teardrop-, and Tetrapod-Shaped CdSe Nanocrystals” J. Am. Chem. Soc. 122:12700-12706. Synthesis of nanoparticles is described in, e.g., U.S. Pat. No. 5,690,807 to Clark Jr. et al. (Nov. 25, 1997) entitled “Method for producing semiconductor particles”; U.S. Pat. No. 6,136,156 to El-Shall, et al. (Oct. 24, 2000) entitled “Nanoparticles of silicon oxide alloys”; U.S. Pat. No. 6,413,489 to Ying et al. (Jul. 2, 2002) entitled “Synthesis of nanometer-sized particles by reverse micelle mediated techniques”; and Liu et al. (2001) “Sol-Gel Synthesis of Free-Standing Ferroelectric Lead Zirconate Titanate Nanoparticles” J. Am. Chem. Soc. 123:4344. Such branched nanofibers can be used in some embodiments herein, e.g., wherein one or more branch is hydrophobic and one or more branch is hydrophilic, etc. Synthesis of nanoparticles is also described in the above citations for growth of nanocrystals, nanowires, and branched nanowires.

Synthesis of core-shell nanostructures, is described in, e.g., Peng et al. (1997) “Epitaxial growth of highly luminescent CdSe/CdS core/shell nanocrystals with photostability and electronic accessibility” J. Am. Chem. Soc. 119:7019-7029; Dabbousi et al. (1997) “(CdSe)ZnS core-shell quantum dots: Synthesis and characterization of a size series of highly luminescent nanocrystallites” J. Phys. Chem. B 101:9463-9475; Manna et al. (2002) “Epitaxial growth and photochemical annealing of graded CdS/ZnS shells on colloidal CdSe nanorods” J. Am. Chem. Soc. 124:7136-7145; and Cao et al. (2000) “Growth and properties of semiconductor core/shell nanocrystals with InAs cores” J. Am. Chem. Soc. 122:9692-9702. Similar approaches can be applied to growth of other core-shell nanostructures. See, for example, U.S. Pat. No. 6,207,229 (Mar. 27, 2001) and U.S. Pat. No. 6,322,901 (Nov. 27, 2001) to Bawendi et al. entitled “Highly luminescent color-selective materials.”

Growth of homogeneous populations of nanofibers, including nanowire heterostructures, in which different materials are distributed at different locations along the long axis of the nanowires is described in, e.g., published PCT application Nos. WO 02/17362, and WO 02/080280; Gudiksen et al. (2002) “Growth of nanowire superlattice structures for nanoscale photonics and electronics” Nature 415:617-620; Bjork et al. (2002) “One-dimensional steeplechase for electrons realized” Nano Letters 2:86-90; Wu et al. (2002) “Block-by-block growth of single-crystalline Si/SiGe superlattice nanowires” Nano Letters 2, 83-86; and U.S. patent application 60/370,095 (Apr. 2, 2002) to Empedocles entitled “Nanowire heterostructures for encoding information.” Similar approaches can be applied to growth of other heterostructures and applied to the various aspects herein.

The present invention also optionally can be used with structures that may fall outside of the size range of typical nanostructures. For example, Haraguchi et al. (U.S. Pat. No. 5,332,910) describe nanowhiskers which are optionally used herein. Semi-conductor whiskers are also described by Haraguchi et al. (1994) “Polarization Dependence of Light Emitted from GaAs p-n junctions in quantum wire crystals” J. Appl. Phys. 75(8): 4220-4225; Hiruma et al. (1993) “GaAs Free Standing Quantum Sized Wires,” J. Appl. Phys. 74(5):3162-3171; Haraguchi et al. (1996) “Self Organized Fabrication of Planar GaAs Nanowhisker Arrays, and Yazawa (1993) “Semiconductor Nanowhiskers” Adv. Mater. 5(78):577-579. Such nanowhiskers are optionally employed as the nanofiber components of the invention.

While many examples herein comprise silicon, again, as previously stated, other materials can optionally be used. For example, the silicon substrate can be replaced with another material (e.g., inorganic), including, but not limited to one or more materials selected from groups II, III, IV, V, or VI of the periodic table of combinations and/or alloys thereof. Additionally, the dopant can also be a material including, but not limited to one or more materials selected from groups II, III, IV, V, or VI of the periodic table or various combinations and/or alloys thereof.

The size (e.g., diameter) and/or shape of the nanofibers can optionally be determined by the size of the gold (or other catalyst) droplet on the substrate. The use of colloidal catalysts (See, e.g., Gudiksen et al., supra) has been shown to significantly improve control of nanofiber diameter and uniformity. Size of the catalyst droplet can also be varied by selective deposition of the gold, or other catalyst, droplets on the substrate (e.g., via molecular beam processes, lithographic processes, and the like). Similarly the distribution of nanofibers on the substrate can be governed by the distribution of the gold or other catalyst on the substrate. Those of skill in the art will be familiar with methods to alter and control nanofiber size, shape, density, etc.

Approaches to make nanowire heterostructures comprising two or more different cores joined together have been reported previously. See, e.g., Lieber, et al. 1999, Nature, 399:48-51. Such processes can be used to create nanofiber heterostructures herein. The processes can involve a catalyst mediated gas phase chemical vapor deposition (CVD) technique where one material is first grown, followed by switching of the growth conditions to fabricate the second material of the heterostructure. In order to grow the heterostructure it is helpful to use a common catalyst for all materials in the heterostructure and have proper control of process conditions (e.g., temperature, pressure, etc.) to achieve a sharp interface junction. Such dual core heterostructures contain two chemically different units that each can be functionalized and processed for preference in either air or liquid binder phase (hydrophobic-hydrophilic) to recreate the proper coating morphology.

In some embodiments herein, the nanofiber heterostructures comprise silicon nanowire-carbon nanotube heterostructures. Both silicon nanowires and carbon nanotubes can be catalyzed by a common material, iron oxide nanocrystal, and reaction conditions for each material can be obtained. Each constituent in such heterostructures is chemically different (e.g., silicon vs. carbon) and, thus, can be modified if desired to segregate appropriately in either hydrophobic or hydrophilic phases. See below.

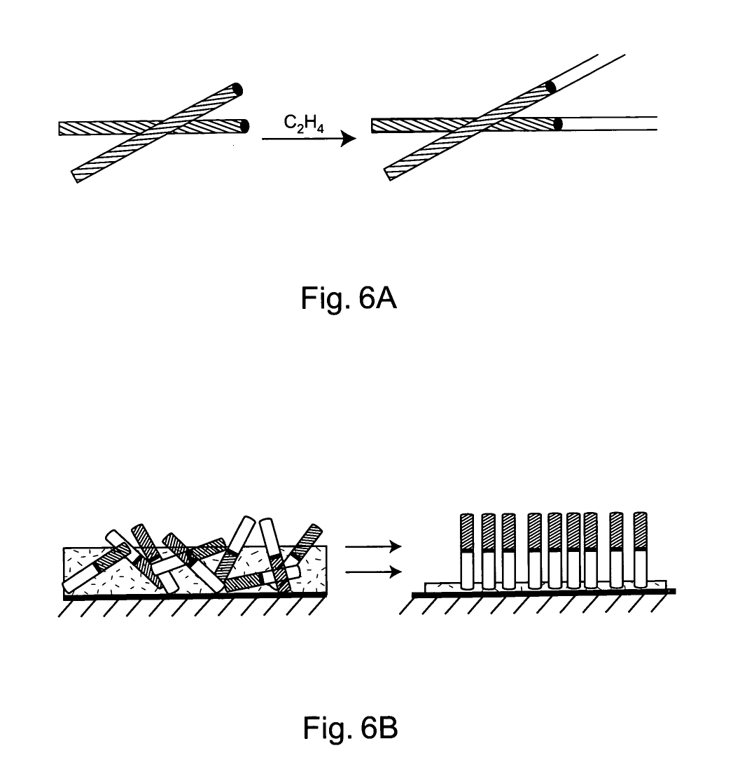

To create silicon nanowire-carbon nanotube heterostructures, iron-oxide nanoparticles with known diameters can be distributed on a silicon wafer by chemical vapor deposition epitaxy (CVDE) from solution followed by removal of the solvent by direct evaporation. The catalyst distribution and size is the fist step in the controlled growth of the nanowire. After removing any left over organic residue by a series of washing steps, the substrate can be placed in a growth furnace, and heated to around 500° C. to grow the silicon nanowire-carbon nanotube heterostructures. The silicon nanowires can be grown first using a growth gas of SiH₄ or SiCl₄, with the iron oxide catalyst remaining at the tip of the growth segment. Following growth of the nanowire, the nanotube can be grown off of the same catalyst. A hydrocarbon based gas can be used after exchanging out the silicon based gas. During each segment growth stage, adjustment of the reactant gas concentration, furnace temperature, and reaction time can be used to control the length of the respective segments. Nanowires with diameters on the order of 10 nm and lengths of 100 um can be grown, however, the exact physical dimensions can be fine turned for optimum hydrophobic and phase segregating behavior as desired. A chemical reaction with fluorinated or hydrocarbon monomers can optionally be applied to the heterostructure nanowire after the growth phase. The silicon nanowire segment will react with the applied chemical agents, resulting in a hydrophobic surface chemistry for that segment only. The end result will be a heterostructure nanowire with two differing phase preferring segments, one that is hydrophobic (silicon nanowire) and the other naturally hydrophilic (carbon nanotube). See FIG. 6. Panel A in FIG. 6 illustrates growth first of silicon nanowires, followed by extension with carbon nanotubes. The silicon nanowires are shown as striated and are grown by a catalytic process that terminates in nanocluster catalysts (in black) which can be removed or allowed to remain at the junction. Such catalysts are used to direct growth of the carbon nanotubes from ethylene. Panel B illustrates a mixture of harvested silicon nanowire-carbon nanotube heterostructures mixed with a carrier matrix (e.g., an epoxy), and their self-segregation with hydrophobic portions out of the epoxy and hydrophilic segments within the matrix.

Surface Additions and Modifications to Nanofiber Heterostructures

In certain embodiments herein, the nanofibers of the invention can comprise an exogenous hydrophobic, hydrophilic, or other material (e.g., a lipophobic material, an amphiphobic material, a matrix stabilizer, etc.). Typically, such material takes the form of an addition or modification of part of the nanofibers of the invention. However, in other embodiments herein, the nanofibers are not totally coated in a traditional sense in that they have a layer, or coat, of chemical covering the entire nanofiber. For example, some embodiments comprise wherein the nanofibers of the invention are treated with a component (e.g., chemical(s), laser(s), exposure to ambient conditions, etc.) which optionally alters the surface of the nanofiber, thus making it hydrophobic, etc., but which does not coat or envelope the surface of the nanofiber in a traditional sense.

In particular embodiments, however, the “core” of the nanofiber, e.g., the silicon fiber itself, acts as a scaffold or the like for a hydrophobic or other modification. It will be appreciated by those of skill in the art that the current invention is not limited by the type of hydrophobic or other aspect associated with the nanofibers. In other words, the actual chemical composition, etc. of the hydrophobic addition/modification (or even the steps involved in a non-chemical treatment resulting in hydrophobicity) are not to be taken as necessarily limiting. Such additions/modifications, etc. are optionally changed and/or chosen based upon a number of parameters, e.g., the liquid to be repelled, the conditions under which the nanofibers are to be used, cost, ease of application, toxicity, eventual use of the nanofibers, the matrix the nanofibers are to be mixed with, durability, etc. and are all within the parameters of the current invention.

In some embodiments herein, the nanofibers of the invention are comprised of multiple additions/modifications of hydrophobic compounds or are comprised through multiple treatments which result in hydrophobicity. Additionally, in other embodiments, the nanofibers are subjected to treatment/coating/etc. with compounds and/or treatments which of themselves do not produce hydrophobicity, but which are intermediaries in a process leading to the final superhydrophobicity of the nanofibers of the invention.

Also, it will be appreciated that in some embodiments herein, the nanofibers of the invention comprise substances (e.g., the additions/modifications, etc.) that in isolation, or when not existing as a component of the nanofibers of the invention, are not hydrophobic at all, or are only mildly hydrophobic. In other words, the hydrophobicity, thus, only arises upon the combination of the nanofibers and the exogenous aspect associated with them, e.g., the chemical addition/modification, application, etc., (while superhydrophobicity arises from the proper morphological arrangement of such treated nanofibers.

Examples of hydrophobic and other compounds which are capable of use in the current invention are given in Table 1. Once again, such listed examples are only for illustrative purposes and should not be taken as necessarily limiting to the invention. Other examples of compounds which are used to treat surfaces and which are hydrophobic and which optionally are used with the nanofibers herein are well known to those of skill in the art. For example, listed compounds (including, e.g., hydrophobic, lipophobic, amphiphobic compounds, etc.) are found in common commercial sources such as chemical catalogues from, e.g., United Chemicals, Sigma-Aldrich, etc. For example, in some embodiments herein, the nanofibers are, e.g., methylated (e.g., by treatment with a methylating agent, etc.), fluorinated, treated with a fluoroalkylsilane group, etc. Some embodiments herein comprise nanofiber coatings of, e.g., Teflon®, silicon polymers (e.g., Hydrolam 100®), polypropylene, polyethylene, wax (e.g., alkylketene dimers, paraffin, fluorocarbon wax, etc.), plastic (e.g., isotactic polypropylene, etc.), PTFE (polytetrafluoroethylene), compounds created through treatment with silane agents, heptadecafluorodecyltrichlorosilane, perfluorooctyltriclorosilane, heptadecafluorodecyltrimethoxysilane, perfluorododecyltrichlorosilane, polyvinyliden fluoride, polyperfluoroalkyl acrylate, octadecanethiol, fluorine compounds (e.g., graphite fluoride, fluorinated monoalkyl phosphates, C₄F₈, etc.). Other sample exogenous compounds optionally used in various embodiments herein can be found in Table 1.

TABLE 1

| Characteristic | Functionality | Chemical Name |
|---|---|---|
| Hydrophobic | C2 | Ethyltrichlorosilane |
| Hydrophobic | C2 | Ethyltriethoxysilane |
| Hydrophobic | C3 | n-Propyltrichlorosilane |
| Hydrophobic | C3 | n-Propyltrimethoxysilane |
| Hydrophobic | C4 | n-Butyltrichlorosilane |
| Hydrophobic | C4 | n-Butyltrimethoxysilane |
| Hydrophobic | C6 | n-Hexyltrichlorosilane |
| Hydrophobic | C6 | n-Hexyltrimethoxysilane |
| Hydrophobic | C8 | n-Octyltrichlorosilane |
| Hydrophobic | C8 | n-Octyltriethoxysilane |
| Hydrophobic | C10 | n-Decyltrichlorosilane |
| Hydrophobic | C12 | n-Dodecyltrichlorosilane |
| Hydrophobic | C12 | n-Dodecyltriethoxysilane |
| Hydrophobic | C18 | n-Octadecyltrichlorosilane |
| Hydrophobic | C18 | n-Octadecyltriethoxysilane |
| Hydrophobic | C18 | n-Octadecyltrimethoxysilane |
| Hydrophobic | C18 | Glassclad-18 |
| Hydrophobic | C20 | n-Eicosyltrichlorosilane |
| Hydrophobic | C22 | n-Docosyltrichlorosilane |
| Hydrophobic | Phenyl | Phenyltrichlorosilane |
| Hydrophobic | Phenyl | Phenyltriethoxysilane |
| Amphiphobic | Tridecafluorooctyl | (Tridecafluoro-1,1,2,2,- |
| | | tetrahydrooctyl)- |
| | | 1-trichlorosilane |
| Amphiphobic | Tridecafluorooctyl | (Tridecafluoro-1,1,2,2,- |
| | | tetrahydrooctyl)- |
| | | 1-triethoxysilane |
| Amphiphobic | | Fluorinated alkanes |
| | | Fluoride containing compounds |
| | | Alkoxysilane |
| | | PTFE |
| | | hexamethyldisilazane |
| | | Aliphatic hydrocarbon containing |
| | | compounds |
| | | Aromatic hydrocarbon containing |
| | | compounds |
| | | Halogen containing compounds |
| | | Paralyene and paralyene |
| | | derivatives |
| | | Fluorosilane containing compounds |
| | | Fluoroethane containing |
| | | compounds |

Harvesting of Nanofibers

In the present invention the nanofibers are harvested from one surface (e.g., the surface upon which they were grown), mixed with an appropriate matrix, and then applied to a second surface (e.g., a surface where they are to be used). The nanofibers can optionally be harvested in any of a number of ways. It will be appreciated by those of skill in the art that such methods of fiber transfer are not necessarily to be considered limiting. For example, nanofibers can be harvested by applying a sticky coating or material to a layer of nanofibers on a first surface and then peeling such coating/material away from the first surface. The nanofibers can then be removed from the sticky coating/material and deposited in the matrix. Examples of sticky coatings/materials which are optionally used for such transfer include, but are not limited to, e.g., tape (e.g., 3M Scotch® tape), magnetic strips, hardening cements (e.g., rubber cement and the like), etc. Other methods of harvesting nanofibers include casting a polymer material onto the nanofibers, thus forming a sheet, and peeling off the sheet. Such sheet can then be transferred (with optional subsequent removal of the polymer) to an appropriate matrix.

Another method of harvesting the nanofibers, e.g., silicon nanowire-carbon nanotube heterostructures from the growth substrate is through use of ultrasonication while in a solution. After the growth stage, the wafer containing the heterostructure nanofibers can be placed in a solvent bath and sonicated. The agitation thus releases the nanofibers from the substrate by releasing the bond to the silicon substrate at the base. The suspension can then be filtered to isolate the removed heterostructures which can then be dispersed into a matrix for processing. Several parameters including sonication power, duration and solvent can be optimized for the process. Specifically, control parameters can be modified so as to not break the bond between segments (e.g., the two halves of the heterostructure) during the agitation process. Sonication harvesting is also optionally used for other nanofibers herein in addition to silicon nanowire-carbon nanotubes.

Another method to harvest nanofibers herein comprises direct shearing mechanisms. For example, the nanofibers can be directly scraped off of the growth wafer with a sharp blade or a fabricated shearing fixture. The latter mechanism provides a controlled normal force pressing two wafers together, while displacing them laterally by a controlled amount. In this way the nanofibers can be removed from the source wafer with control over the amount of applied force and the direction of shear. After removal, the nanofibers optionally can be fully characterized for morphology, diameter, length, and overall uniformity.

Matrix Compositions

In the various embodiments herein, the nanofiber heterostructures are mixed with, and used in conjunction with, various coating matrices. Such matrices can comprise a wide range of different components and be based upon a number of different compositions depending upon the specific nanofiber heterostructures to be used, the use of the nanofiber coating, etc. Thus, specific recitation of matrices or matrix components herein should not be taken as necessarily limiting.

In general, the compositions of the matrices herein comprise a liquid formulation (although dry formulations of resins, etc. are also included) in which the nanofiber heterostructures can be mixed or suspended so as to form an organized layer of nanofiber heterostructures of a desired density once applied to a surface (i.e., in order to create a surface of the desired hydrophobicity). Specific formulations can be also optionally chosen based on drying/curing/setting aspects of the matrix as well as its ability to adhere to the surface to which it is applied. Many commercial coatings are blends or emulsions containing, e.g., pigments, particles, polymeric binder(s) and solvent(s). Similarly, the current invention optionally can also comprise one or more components such as solvents (e.g., to help in mixing of the various components and in creating the proper viscosity), dispersants (e.g., to help create the proper density of nanofibers upon the surface), curing agents (e.g., to help in setting or curing of the matrix), structural components—binders (such as various polymers, polymer subunits, linking agents, etc.), and various fungicides, biocides, etc. Those of skill in the art will be familiar with various coating compositions and with the range of resins, polymers, solvents, epoxies, etc., that are available and which would be amenable for use in the current invention.

In various embodiments, the heterostructures can be formulated so that both of their ends are compatible with, or miscible with, the coating/matrix solution before curing/setting. However the formulations can be such that, upon solvent evaporation or curing only one end of the heterostructure will remain compatible with the coating. Thus, the compatible end will serve as the anchor while the other non-compatible end will protrude from the surface of the set matrix. In other embodiments, the matrix and one end of the heterostructure will not be compatible even before the matrix cures/sets.

An example of a nanofiber composition herein can optionally include a silicone elastomer coating system and a silicon nanowire-carbon nanotube heterostructure. Surface functionalization of the ends of the nanostructure (e.g., the silicon nanowire end of a nanowire-nanotube heterostructure) can be optimized for maximum compatibility with the various matrix components, e.g., the polymer coating such as silicone or epoxy, the solvent carrier, and the like. In such exemplary composition, silicone ligands can first be attached to the silicon side of the heterostructure by standard silane chemistry. In such example, the carbon nanotube end can also be treated if necessary to maintain the desired hydrophobicity/hydrophilicity. The polymer type and molecular weight of the binder(s) in the matrix can be optimized to form the functional protective coating while facilitating self-assembly of the nanostructured superhydrophobic layer. In some instances, such as in the exemplary mixture, by choosing a hydrocarbon solvent in which to base the mixture, the silicone polymer, the carbon nanotube end of the heterostructure and the silicone coated silicon nanowire end of the heterostructure can all be miscible in the composition. However, when such composition is applied to a surface (e.g., a medical device surface, etc.), the solvent will evaporate. As evaporation takes place, the silicone coated silicon nanowire and the silicone binder polymer will remain compatible, but the carbon nanotube end of the heterostructure will not. The carbon nanotube end of the heterostructure will be forced out of the surface of the composition, thus creating the desired superhydrophobic morphology.

As will be appreciated, many other formulations and combinations are also possible within the invention. Thus, for example, urethane moieties can be attached to the silicon nanowire end of such heterostructures while the matrix can be based on a polyurethane composition and the like.

In various embodiments herein, the heterostructure compositions can comprise binders or structural components such as (but not limited to) one or more: acrylic, epoxy, resin, polyester, polyurethane (including those in waterborne polyurethane dispersions and aqueous polyurethane resins as well as solvent-based polyurethanes), polyacrylate, latex, alkyd resin, polyurea, silicone, polysilicone, etc. The compositions can also include other constituents such as UV absorbers, fillers, colorants, pigments, crosslinking agents, coalescing solvents, emulsifiers, etc. Again, those of skill in the art will be familiar with numerous binders/structural components that are amenable to the current invention.

As stated previously, a wide number of compounds are optionally utilized in the compositions and coatings herein as structural components or binders. Such compounds can be a polymeric or polymerizable binder (e.g., ones that are water-soluble, water-dissipatable, or those that are non-water soluble polymeric or polymerizable). Examples of water-soluble binders include starches, e.g., hydroxy alkyl starches, for example hydroxyethylstarch; celluloses, for example cellulose, methylcellulose, hydroxyethylcellulose, hydroxypropylcellulose, hydroxyethyl methyl cellulose and carboxymethlycellulose (and salts thereof) and cellulose acetate butyrate; gelatin; gums, for example guar, xanthan gum and gum arabic; polyvinylalcohol; polyvinylphosphate; polyvinylpyrrolidone; polyvinylpyrrolidine; polyethylene glycol; hydrolysed polyvinylacetate; polyethylene imine; polyacrylamides, for example polyacrylamide and poly(N,N-dimethyl acrylamide); acrylamide-acrylic acid copolymers; polyvinylpyridine; polyvinylphosphate; vinylpyrrolidone-vinyl acetate copolymers; vinyl pyrrolidone-styrene copolymers; polyvinylamine; poly(vinyl pyrrolidonedialkylaminoalkyl alkylacrylates), for example poly vinylpyrrolidone-diethylaminomethylmethacrylate; acid-functional acrylic polymers and copolymers, for example poly(meth)acrylic acid and copolymers of (meth)acrylic acid and other (meth)acrylate monomers; amine-functional acrylic polymers and copolymers, for example polydimethylaminoethylmethacrylate; acid or amine functional urethane polymers, e.g., those containing dimethylolpropanoic acid and/or pendant or terminal polyethylene glycols; ionic polymers, cationic polymers, for example poly (N,N-dimethyl-3,5-dimethylene piperidinium chloride); and polyesters, such as those which carry water-solubilizing groups, or acid groups, for example polyesters obtainable by polymerizing a polyol with sodiosulphoisophthalic acid, etc.

Examples of water-dissipatable binders or structural components capable of use herein include, e.g., water-dissipatable polymers, for example, latex polymers, for example cationic, nonionic, and anionic surface modified styrene-butadiene latexes; vinyl acetate-acrylic copolymer latexes; acrylic copolymer latexes which carry quaternary ammonium groups, for example a polymethylacrylate trimethylammonium chloride latex; and dispersions of poly(acrylate), poly(methacrylate), polyester, polyurethane or vinyl polymers and copolymers thereof. The polymer dispersions may be prepared, for example, by emulsion, suspension, bulk or solution polymerization followed by dispersion into water. The binder may comprise a single binder or comprise a mixture of two or more binders, e.g., exemplary binders described herein.

Oligomeric polyols may be used to provide toughness and hydrophobic or hydrophilic characteristics to the formulations herein. Oligomeric polyols are defined as polyols having a number average molecular weight between about 500 and 5000 Daltons. Members of this class include polyester diols, polyether diols and polycarbonate diols.

Other useful additives which can help to control drying rate of the compositions herein include trimethylol propane, urea and its derivatives, amides, hydroxyether derivatives such as butyl carbitol or Cellosolve™, amino alcohols, and other water soluble or water miscible materials, as well as mixtures thereof. Other additives commonly known in the art which are optionally added include biocides, fungicides, defoamers, corrosion inhibitors, viscosity modifiers, pH buffers, penetrants, sequestering agents, and the like. The heterostructures can also be incorporated with a water-soluble high polymer such as PVA or PVP, a thermosetting resin such as acryl emulsion, or a crosslinking agent such as ADC or diazonium salt may be added, if necessary.

In some embodiments, the compositions herein can comprise one or more dispersant. See, e.g., “Nanowire Dispersion Compositions and Uses Thereof,” Attorney Docket Number 40-0069-10PC, filed Apr. 6, 2005.

The various components or constituents in the coatings can be suspended in one or more liquid such as water (or other aqueous based liquids), organic solvents, etc. Other embodiments, can comprise dry solutions without a liquid carrier. The amount of organic solvent and/or water within the liquid medium can depend on a number of factors, such as the particularly desired properties of the composition such as the viscosity, surface tension, drying rate, etc. The organic solvent, if present, can be any number of organic solvents known to those of ordinary skill in the art. For example, suitable water-miscible organic solvents include C1-5-alkanols, e.g. methanol, ethanol, n-propanol, isopropanol, n-butanol, sec-butanol, tert-butanol and isobutanol; amides, e.g. dimethylformamide and dimethylacetamide; ketones and ketone alcohols, e.g. acetone and diacetone alcohol; C2-4-ether, e.g. tetrahydrofuran and dioxane; alkylene glycols or thioglycols containing a C2-6 alkylene group, e.g. ethylene glycol, propylene glycol, butylene glycol, pentylene glycol and hexylene glycol; poly(alkylene-glycol)s and thioglycol)s, e.g. diethylene glycol, thiodiglycol, polyethylene glycol and polypropylene glycol; polyols, e.g. glycerol and 1,2,6-hexanetriol; and lower alkyl glycol and polyglycol ethers, e.g., 2-methoxyethanol, 2-(2-methoxyethoxy)ethanol, 2-(2-ethoxyethoxy) ethanol, 2-(2-butoxyethoxy)ethanol, 3-butoxypropan-1-o1, 2-[2-(2-methoxyethoxy)-et-hoxy]ethanol, 2-[2-(2-ethoxyethoxy)ethoxy]-ethanol; cyclic esters and cyclic amides, e.g. optionally substituted pyrrolidones; sulpholane; and mixtures containing two or more of the aforementioned water-miscible organic solvents.

Morphological Characteristics of Coatings

An aspect of the current invention is the density of the nanofibers in the coatings of the invention. As explained above, superhydrophobicity of surfaces typically includes the concept of surface roughness. See, e.g., Equations 2-5 above and FIG. 3. Therefore, the density of the nanofibers in the coatings herein, which leads to varying degrees of roughness, is believed to have a bearing on the superhydrophobicity of the invention. More importantly, the ability to control the nanofiber density provides a unique ability to control the level of superhydrophobicity of the overall coating on the surface, e.g., making some surfaces more hydrophobic than others, etc. As will be appreciated, the various nanofibers herein can comprise different diameters, lengths, conformations, etc. in different embodiments. Those of skill in the art will be familiar with the different ways to control such factors in the production/growth of various nanofibers. See above.

The concept of density herein is optionally approached in several different ways, all of which are encompassed in the present invention. For example, one definition of nanofiber density consists of the number of nanofibers per unit area of the coating present on a substrate. Different embodiments of the invention can comprise a range of such different densities. The number of nanofibers per unit area can optionally range from about 1 nanofiber per 10 micron² or less up to about 2000 nanofibers per micron²; from about 1 nanofiber per micron² or less up to about 1500 nanofibers per micron²; from about 10 nanofibers per micron² or less up to about 1000 nanofibers per micron²; from about 25 nanofibers per micron² or less up to about 750 nanofibers per micron²; from about 50 nanofibers per micron² or less up to about 500 nanofibers per micron²; from about 75 nanofibers per micron² or less up to about 500 nanofibers per micron² from about 100 nanofibers per micron² or less up to about 250 nanofibers per micron²; or from about 125 nanofibers per micron² or less up to about 175 nanofibers per micron².

Because in different embodiments the nanofibers herein can optionally comprise different diameters, nanofiber density can also be defined in terms of percent coverage of the coating present on the substrate surface. In other words, the percentage of the total area of the coating which is taken up by the footprints of the nanofibers themselves. Typically such percentage is determined based upon the nanofiber core. However, in some embodiments, e.g., wherein an exogenous hydrophobic material comprises a thick application on the nanofiber members, the percentage is optionally based upon the footprint of the nanofiber core and the exogenous application present on the nanofiber member. For example, if a nanofiber herein were covered with a thick plastic moiety, then the percentage of the coating surface covered could optionally be determined based upon the diameter of the core nanofiber plus the plastic on it. As will be appreciated, percent surface coverage density is one factor having a bearing upon values in Cassie's equation. See, Equations 4 and 5 above. For example, the values of ‘a’ in FIG. 3 would change in embodiments wherein a nanofibers comprised a bulky moiety (thus making the diameter greater) as opposed to an extremely thin one. Again, however, it will be appreciated that this but one factor in determination of hydrophobicity. In some embodiments, the nanofibers comprise a percent surface coverage of the coating surface of from about 0.01% or less to about 50%; from about 0.25% or less to about 40%; from about 0.5% or less to about 30%; from about 1% or less to about 20%; or from about 5% or less to about 15%.

Exemplary Uses and Applications

The superhydrophobic coatings of the current invention are applicable for a large number of applications on various materials including flexible and/or low temperature plastics. The potential applications of this technology are extremely broad. For example, breathable, water-repellent uniforms, water-repellent paint topcoats for sensitive field instruments, coatings on toys and medical devices/implants, and coatings that reduce drag on ships, land vehicles, and aircraft, are all exemplary uses of the coatings of the invention. The various surfaces to which the coatings of the invention are applied can cause liquid drops placed on such surfaces to display a contact angle of, e.g., at least 150° or more, at least 160° or more, at least 170° or more, at least 175° or more, at least 176° or more, at least 177° or more, at least 178° or more, at least 179° or more, or at least 179.5° or more.

Further exemplary applications of the coatings herein include use on water borne ships. For example, as a superhydrophobic coated vessel moves in the water, the liquid-air-sold interface of the coating reduces drag, thus, providing an increase in propulsion efficiency. Furthermore, the propensity of a ship's hull to corrode can be greatly reduced since by use of the coatings herein, water will have minimal interaction with the actual metal surface. Such corrosive protection is also applicable to many other surfaces exposed to water/moisture.

Windows, instrumentation, and glass optics comprising the coatings herein can allow increased visibility in situations where visibility otherwise would be reduced due to moisture, water, or ice. Additionally, superhydrophobic coatings of the invention can be used on antennae and other communication equipment to reduce the power loss caused by absorption and diffraction.

Further applications of the coatings herein can involve assisting in water capture such as in channels on a surface that guide water droplets or condensation toward a specific location. Also, since the coatings herein can optionally be applied to flexible substrates such as various fabrics and textiles, equipment such as tents, outdoor clothing and the like can optionally utilize the coatings herein. The coatings of the invention can be applied to various fabrics/textiles in order to optionally increase vapor resistance (hydro-head), increase resistance to penetration of water under pressure, and increase moisture vapor permeability resistance which measures the passage of gaseous water, e.g., according to standard ATSM testing methods, of such fabrics/textiles.

For example, as disclosed in the above-referenced applications, the unique nanostructured coatings disclosed herein can be used in, on or within various medical devices, such as clamps, valves, intracorporeal or extracorporeal devices (e.g., catheters), temporary or permanent implants, stents, vascular grafts, anastomotic devices, aneurysm repair devices such as aneurysm coils, embolic devices, implantable devices (e.g., orthopedic or dental implants) and the like. Such enhanced surfaces provide many enhanced attributes to the medical devices in, on, or within which they are used including, e.g., to prevent/reduce bio-fouling, increase fluid flow due to hydrophobicity, biointegration, etc. Such nanostructured coatings can be used as surface coatings for touch screens such as for information kiosks, gaming/entertainment/media consoles, point-of-sale terminals, ATM machines, kiosks in retailing, personal computer monitor screens, automobile displays, and the like. The nanostructured coatings disclosed herein can be used to provide a surface for cell attachment, differentiation, and proliferation, as a substrate to promote cell growth, or as a substrate for DNA or protein microarrays, e.g., to hybridize nucleic acids, proteins and the like. The nanostructured films disclosed herein have applications in vivo for tissue grafting including osteoblasts, neuronal, glia, epidermal, fibroblast cells and the like.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

What is claimed is:

1. A composition comprising a plurality of heterostructure nanofibers and a liquid matrix.

2. The composition of claim 1, wherein each member of the plurality of nanofibers comprises a hydrophobic end and a hydrophilic end.

3. The composition of claim 1, wherein the liquid matrix comprises an aqueous fluid.

4. The composition of claim 1, wherein the liquid matrix comprises a nonaqueous fluid.

5. The composition of claim 1, wherein the liquid matrix comprises a curable liquid.

6. The composition of claim 1, wherein one or both ends of a majority of the members of the plurality comprises one or more surface application.

7. The composition of claim 6, wherein the surface application alters or enhances hydrophobicity, hydrophilicity, and/or wherein the surface application alters or enhances stability of the nanofiber within the matrix.

8. The composition of claim 5, wherein when the liquid matrix is cured, one end of a majority of the members of the plurality of nanofibers is set within the cured liquid matrix and one end protrudes from the liquid matrix.

9. The composition of claim of claim 1, wherein the heterostructure nanofibers comprise a silicon nanowire end and a carbon nanotube end.

10. The composition of claim 1, wherein the liquid matrix comprises an epoxy, resin, or liquid polymer.

11. An applied coating on a surface, the coating comprising, a plurality of heterostructure nanofibers set within a matrix; wherein each member of the plurality comprises a hydrophobic end and a hydrophilic end; and wherein one end of a majority of the members of the plurality is set within the matrix and one end protrudes from the matrix.

12. The coating of claim 11, wherein the matrix comprises an aqueous composition.

13. The coating of claim 11, wherein the matrix comprises a nonaqueous composition.

14. The coating of claim 11, wherein the matrix is applied to the surface as a curable liquid.

15. The coating of claim 11, wherein one or both ends of a majority of the members of the plurality comprises one or more surface application.

16. The coating of claim 15, wherein the surface application alters or enhances hydrophobicity, hydrophilicity, and/or wherein the surface application alters or enhances stability of the nanofiber within the matrix.

17. The coating of claim 11, wherein the heterostructure nanofibers comprise a silicon nanowire end and a carbon nanotube end.

18. The coating of claim 11, wherein the matrix comprises an epoxy, resin, or cured liquid polymer.

19. A surface comprising the coating of claim 11.

20. The surface of claim 19, wherein the surface comprises one or more of: metal, plastic, cloth, or fiber.

21. A method of producing a hydrophobic or hydrophilic surface, the method comprising applying the composition of claim 1 to a surface; and, curing the composition.

22. A method of making the composition of claim 1, the method comprising combining the plurality of heterostructure nanofibers and the liquid matrix.

23. A composition comprising one or more nanofiber heterostructures, wherein the heterostructures comprise a hydrophilic end and a hydrophobic end and wherein one or both ends of the one or more nanofiber heterostructures comprises one or more surface coating.

24. The composition of claim 23, wherein the hydrophilic end comprises a silicon nanowire.

25. The composition of claim 23, wherein the hydrophobic end comprises a carbon nanotube.

26. A surface comprising a plurality of heterostructures of claim 23.

27. The surface of claim 26, wherein the surface comprises a flexible plastic and/or a low-temperature material.

28. The composition of claim 23, wherein the one or more surface coating comprises a fluorinated compound deposited on at least said hydrophobic end of the one or more nanofiber heterostructures.
